(19) United States
(12) Patent Application Publication
(10) Pub. No.: US 2026/0230204 A1
(43) Pub. Date: Aug. 6, 2026

(54) METHODS AND APPARATUSES FOR DOWNLINK CONTROL SIGNALING

(71) Applicant: InterDigital Patent Holdings, Inc., Wilmington, DE (US)

(72) Inventors: Aata El Hamss, Laval (CA); Jonghyun Park, Syosset, NY (US); Tao Deng, New York, NY (US); Nazli Khan Beigi, Longueuil (CA); Virgile Garcia, Antibes (FR)

(73) Assignee: InterDigital Patent Holdings, Inc., Wilmington, DE (US)

(21) Appl. No.: 19/044,351

(22) Filed: Feb. 3, 2025

(51) Int. Cl. H04B 17/345; H04L 5/00; H04W 24/08

(52) U.S. Cl. CPC H04B 17/345; H04L 5/0053; H04W 24/08

(57) ABSTRACT

Methods, systems, and apparatuses for downlink control signaling are provided. In an example, a wireless transmit/receive unit (WTRU) may be configured with a first search space associated with a first control resourceset (CORESET) that includes one or more subband full-duplex (SBFD) symbols. The WTRU may be configured with a second search space associated with a second CORESET that includes one or more non-SBFD symbols. The WTRU monitors the first search space. When the WTRU determines that a cross-link interference (CLI) is high, the WTRU stops monitoring the first search space and starts monitoring the second search space for a configured time window.

### BACKGROUND

With carrier aggregation (CA), more downlink control resources are needed for downlink control signaling to schedule wireless transmit/receive units (WTRUs) in an aggregated carrier mode, compared to a single carrier mode. Using subband full duplex (SBFD) mode reduces downlink bandwidth and thus reduces the available downlink control resources. Total available resources for scheduling multiple carriers are reduced when the SBFD mode is used on multiple carriers. Furthermore, the downlink resources may suffer from cross link interference (CLI) caused by the WTRUs transmitting in an uplink (UL) sub-band. Therefore, there is a need to configure downlink control channels in SBFD carriers given limited downlink control resources and the CLI from the uplink transmissions.

### SUMMARY

In one or more embodiments, a wireless transmit/receive unit (WTRU) is provided. The WTRU comprises a transceiver and a processor. The transceiver and the processor are configured to receive configuration information indicative of a first search space and a second search space. The first search space is associated with a first control resource set (CORESET) comprising one or more subband full-duplex (SBFD) symbols. The second search space is associated with a second CORESET comprising one or more non-SBFD symbols. The transceiver and the processor are configured to monitor the first search space for physical downlink control channel (PDCCH), and measure a cross link interference (CLI) in a carrier associated with the first search space. The transceiver and the processor are configured to determine that the measured CLI is greater than a threshold CLI, stop monitoring the first search space, monitor the second search space, and transmit, to a base station, an indication of high CLI.

In an embodiment, the transceiver and the processor are further configured to determine that the measured CLI is not greater than the threshold CLI, and continue monitoring the first search space.

In an embodiment, the transceiver and the processor are further configured to, based on the determination that the measured CLI is greater than the threshold CLI, initialize a timer for a configured time window, resume monitoring the first search space upon expiry of the timer, and stop monitoring the second search space upon expiry of the timer.

In an embodiment, the transceiver and the processor are further configured to, based on the determination that the measured CLI is greater than the threshold CLI, receive the PDCCH in the second search space within the configured time window.

In an embodiment, the transceiver and the processor are further configured to, based on the determination that the measured CLI is greater than the threshold CLI, receive, from the base station, a confirmation indication in response to transmitting the indication of high CLI, stop monitoring the first search space based on the confirmation indication, and monitor the second search space based on the confirmation indication.

In an embodiment, the indication of high CLI is transmitted using at least one of: physical uplink control channel (PUCCH) or physical uplink shared channel (PUSCH).

In an embodiment, measuring the CLI comprises measuring one or more reference signal resources.

In one or more embodiments, a method for use in a WTRU is provided. The method comprises receiving configuration information indicative of a first search space and a second search space. The first search space is associated with a first CORESET comprising one or more SBFD symbols. The second search space is associated with a second CORESET comprising one or more non-SBFD symbols. The method includes monitoring the first search space for PDCCH. The method includes measuring a CLI in a carrier associated with the first search space. The method includes determining that the measured CLI is greater than a threshold CLI, stopping monitoring the first search space, monitoring the second search space, and transmitting, to a base station, an indication of high CLI.

In an embodiment, the method further comprises, determining that the measured CLI is not greater than the threshold CLI, and continuing monitoring the first search space.

In an embodiment, the method further comprises, based on the determination that the measured CLI is greater than the threshold CLI, initializing a timer for a configured time window, resuming monitoring the first search space upon expiry of the timer, and stopping monitoring the second search space upon expiry of the timer.

In an embodiment, the method further comprises, based on the determination that the measured CLI is greater than the threshold CLI, receiving the PDCCH in the second search space within the configured time window.

In an embodiment, the method further comprises, based on the determination that the measured CLI is greater than the threshold CLI, receiving, from the base station, a confirmation indication in response to transmitting the indication of high CLI, stopping monitoring the first search space based on the confirmation indication, and monitoring the second search space based on the confirmation indication.

In an embodiment, the indication of high CLI is transmitted using at least one of: PUCCH or PUSCH.

In an embodiment, measuring the CLI comprises measuring one or more reference signal resources.

In one or more embodiments, a WTRU comprising a transceiver and a processor is provided. The transceiver and the processor are configured to receive configuration information indicative of a first search space and a second search space. The first search space is associated with a first CORESET comprising one or more SBFD symbols and the second search space is associated with a second CORESET comprising one or more non-SBFD symbols. The transceiver and the processor are configured to monitor the first search space and the second search space for PDCCH. The transceiver and the processor are configured to measure a CLI in a carrier associated with the first search space. The transceiver and the processor are configured to determine that the measured CLI is greater than a threshold CLI, and stop monitoring the first search space. The transceiver and the processor are configured to transmit, to a base station, an indication of high CLI.

In an embodiment, the transceiver and the processor are further configured to, determine that the measured CLI is not greater than the threshold CLI, and continue monitoring the first search space.

In an embodiment, the transceiver and the processor are further configured to, based on the determination that the measured CLI is greater than the threshold CLI, initialize a timer for a configured time window. The transceiver and the processor are further configured to resume monitoring the first search space upon expiry of the timer.

In an embodiment, the transceiver and the processor are further configured to, based on the determination that the measured CLI is greater than the threshold CLI, receive the PDCCH in the second search space within the configured time window.

In an embodiment, the transceiver and the processor are further configured to, based on the determination that the measured CLI is greater than the threshold CLI, receive, from the base station, a confirmation indication in response to transmitting the indication of high CLI, and stop monitoring the first search space based on the confirmation indication.

In an embodiment, the indication of high CLI is transmitted using at least one of: PUCCH or PUSCH.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example carrier aggregation with a subband full duplex (SBFD) configuration according to one or more embodiments;

FIG. 3 is a diagram illustrating an example SBFD configuration according to one or more embodiments;

FIG. 4 is a diagram illustrating an example configuration of two control resource sets (CORESETs) according to one or more embodiments;

FIG. 5 is a diagram illustrating an example configuration of first and second search space sets according to one or more embodiments;

FIG. 6 is a diagram illustrating an example configuration of one or more search space sets in carrier aggregation (CA) mode according to one or more embodiments; and

FIG. 7 is a flowchart illustrating an example process of downlink control signaling for SBFD systems according to one or more embodiments.

### DETAILED DESCRIPTION

As discussed herein, one or more abbreviations in the following (non-exhaustive) list, shown in Table 1, may be used herein.

TABLE 1

| | |
|---|---|
| ACK | Acknowledgement |
| BWP | Bandwidth Part |
| CCE | Control Channel Element |
| CLI | Cross Link Interference |
| CG | Configured grant or cell group |
| CP | Cyclic Prefix |
| CP-OFDM | Conventional OFDM (relying on cyclic prefix) |
| CQI | Channel Quality Indicator |
| CRC | Cyclic Redundancy Check |
| CSI | Channel State Information |
| DCI | Downlink Control Information |
| DL | Downlink |
| DM-RS | Demodulation Reference Signal |
| DRB | Data Radio Bearer |
| HARQ | Hybrid Automatic Repeat Request |
| NACK | Negative ACK |
| MCS | Modulation and Coding Scheme |
| NR | New Radio |
| OFDM | Orthogonal Frequency-Division Multiplexing |
| PHY | Physical Layer |
| PO | Paging Occasion |
| PRACH | Physical Random Access Channel |
| PRB | Physical Resource Block |
| R2D | Reader-to-Device |
| RB | Resource Block |
| RF | Radio Front end |
| RLF | Radio Link Failure |
| RLM | Radio Link Monitoring |
| RNTI | Radio Network Identifier |
| RO | RACH occasion |
| RRC | Radio Resource Control |
| RRM | Radio Resource Management |
| RS | Reference Signal |
| RSRP | Reference Signal Received Power |
| RSSI | Received Signal Strength Indicator |
| SBFD | Subband full duplex |
| SS | Synchronization Signal |
| SSS | Secondary Synchronization Signal |
| SRS | Sounding Reference Signal |
| SPS | Semi-persistent scheduling |
| SUL | Supplemental Uplink |
| TB | Transport Block |
| TBS | Transport Block Size |
| TRP | Transmission/Reception Point |
| TSC | Time-sensitive communications |
| UE | User Equipment b |
| UL | Uplink |
| URLLC | Ultra-Reliable and Low Latency Communications |
| WBWP | Wide Bandwidth Part |
| WLAN | Wireless Local Area Networks and related technologies |
| | (IEEE 802.xx domain) |

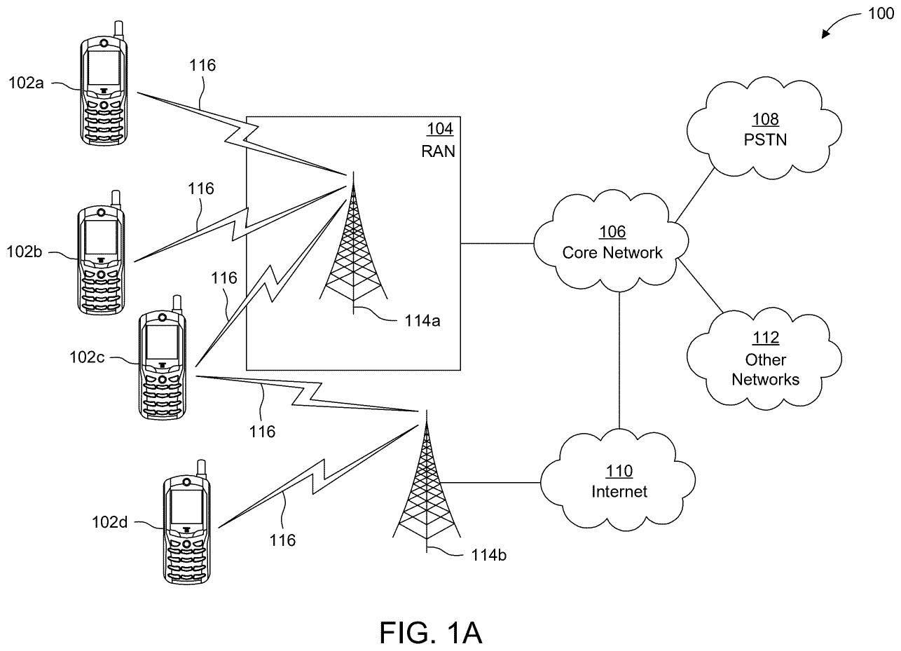

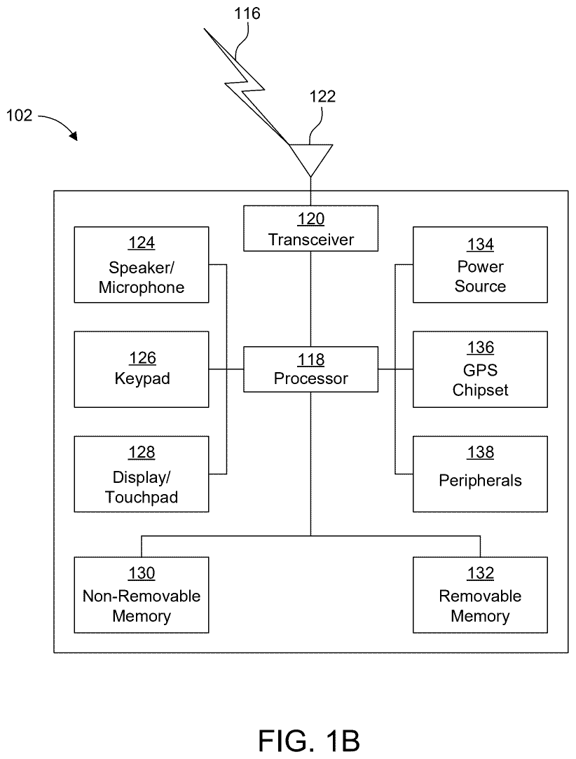

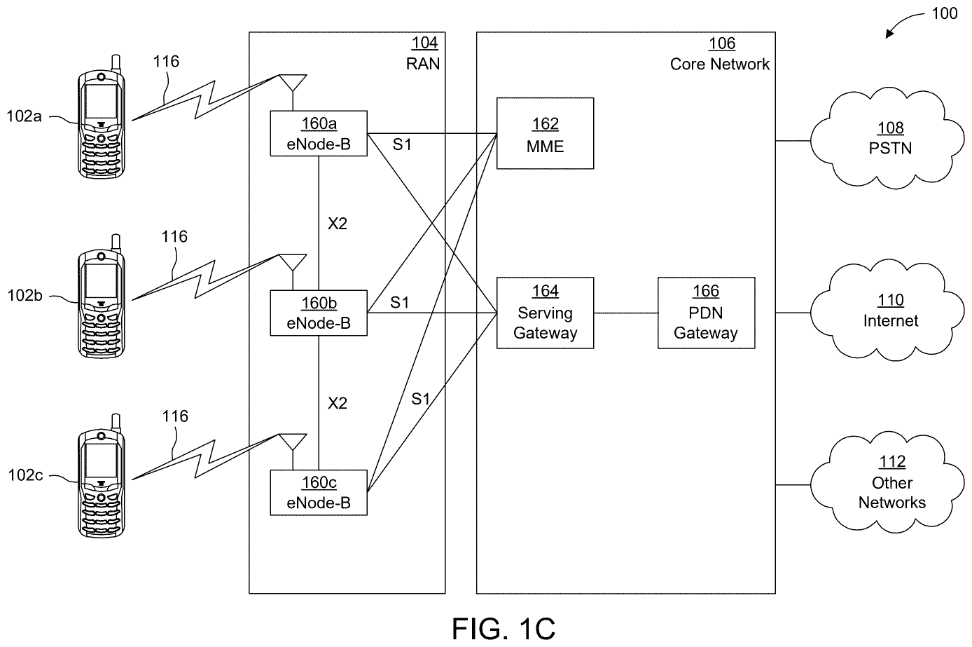

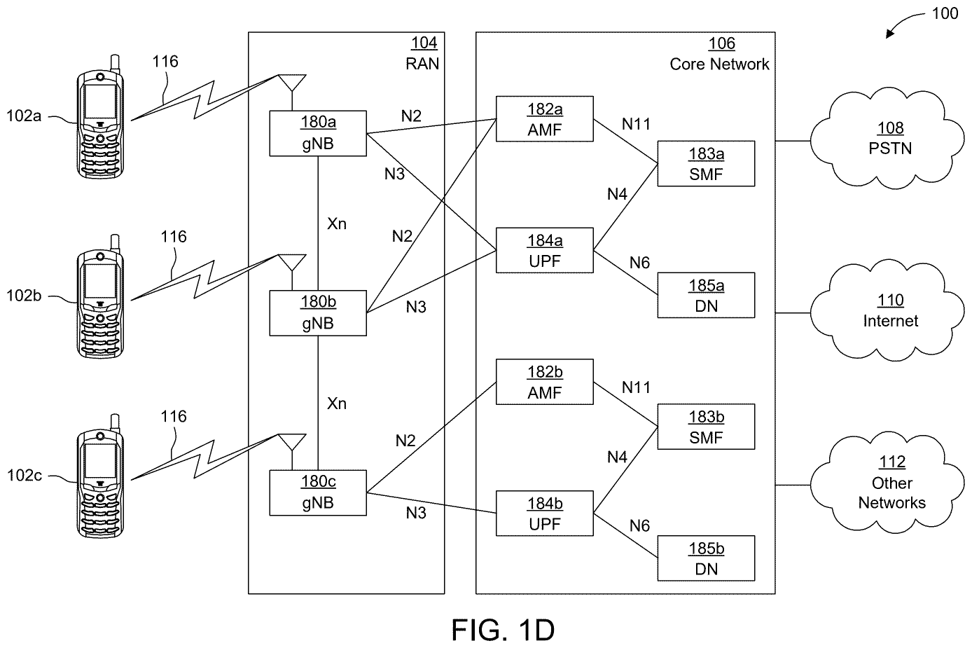

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

There are two modes of operation in current communication systems, viz. frequency division duplex (FDD) mode and time division duplex (TDD) mode. In the FDD mode, downlink (DL) and uplink (UL) transmissions may be configured at the same time but using different carrier frequencies. In the TDD mode, the DL and UL transmissions may be separated in a time domain. This time restriction may limit data throughput especially for the UL. To solve this limitation of resource availability in one direction (i.e., the DL or the UL), full duplex mode is used in NR systems.

The full duplex mode facilitates a base station (e.g., gNB) and a WTRU to transmit and/or receive in same carrier bandwidth at the same time. In sub-band full duplex (SBFD) mode, a carrier is divided into multiple sub-bands and each sub-band may have transmissions in only one direction. In an example, one SBFD configuration may be to divide a carrier into three sub-bands, with a first sub-band configured for downlink transmission, a second sub-band configured for uplink transmission and a third sub-band configured for downlink transmission. The three sub-bands may be separated by a gap in frequency domain to protect the transmissions from cross link interference (CLI).

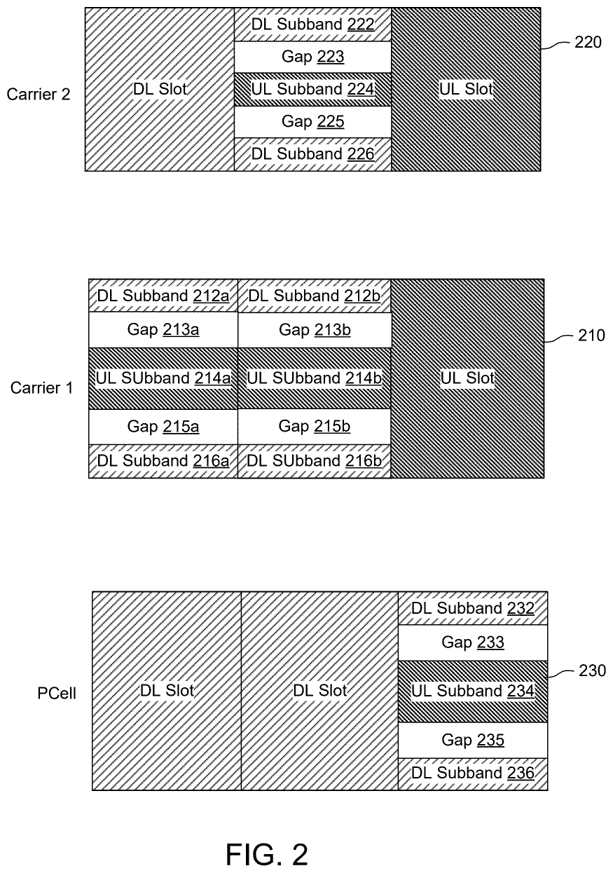

Referring now to FIG. 2, an example carrier aggregation with an SBFD configuration is shown according to one or more embodiments. FIG. 2 illustrates a first carrier 210 (i.e. carrier 1), a second carrier 220 (i.e. carrier 2), and a primary component carrier (PCC) 230 of a primary cell (PCell). In the SBFD configuration illustrated in FIG. 2, the SBFD configuration may divide the first carrier 210, the second carrier 220, and/or the PCC 230 into multiple subbands. In the first carrier 210 in a first slot, two DL subbands 212a and 216a may be separated by two gaps 213a and 215a from a first uplink subband 214a in frequency domain to protect the transmissions from CLI. In the first carrier 210 in a second slot, two DL subbands 212b and 216b may be separated by two gaps 213b and 215b from a second uplink subband 214b in frequency domain. Similarly, in the second carrier 220, two DL subbands 222 and 226 may be separated by two gaps 223 and 225 from an uplink subband 224 in frequency domain. Similarly, in the PCC 220, two DL subbands 232 and 236 may be separated by two gaps 233 and 235 from an uplink subband 234 in frequency domain.

The carrier aggregation may further increase the available bandwidth for the UL in the TDD mode. Multiple carriers may be configured to the WTRU to achieve high data throughput. Combining the full duplex mode and the carrier aggregation mode may offer more bandwidth and allow more opportunities for the UL in the TDD mode.

With the carrier aggregation, more resources are needed for downlink control signaling to schedule multiple WTRUs in the aggregated carriers (compared to a single carrier mode). Using the SBFD reduces the downlink bandwidth and thus reduces the available downlink control resources. The total available resources for scheduling multiple carriers are reduced when the SBFD is used on the multiple carriers. Furthermore, the downlink resources may suffer from cross link interference caused by the WTRUs transmitting in UL sub-bands. Therefore, there is a need to configure the downlink control channels in the SBFD carriers given the limited downlink control resources and the cross link interference from the UL.

In an embodiment, one or more methods and apparatuses for determining multiple search space sets to monitor as a function of the cross link interference, a maximum blind decoding capability, and/or the scheduling activity are provided. The WTRU may be configured with at least two search space sets to schedule transmissions in a carrier configured with SBFD. The WTRU may be configured with a first search space set associated with a first CORESET that includes one or more SBFD symbols. The WTRU may be configured with a second search space set associated with a second CORESET that includes one or more non-SBFD symbols The WTRU may monitor the first search space set for possible scheduling in the carrier. The WTRU may determine a high level of cross link interference in the carrier where the first CORESET is configured (e.g., the WTRU determines a high level of cross link interference when one or more measurement results of configured SRS and/or CSI resources is above a configured threshold). The WTRU may stop monitoring the first search space set and monitor the second search space set. The WTRU may indicate to the base station (e.g., gNB) that the WTRU stopped monitoring the first search space set and started monitoring the second search space set (e.g., the WTRU transmits the indication in a PUCCH resource). The WTRU may stop monitoring the first search space set and start monitoring the second search space set during a configured time window (e.g., the WTRU starts a timer when the CLI is above the configured threshold).

In an example, the WTRU indicates high CLI to the gNB and waits for a confirmation to stop monitoring the first search space and start monitoring the second search space. When the WTRU receives the confirmation, the WTRU stops monitoring the first search space set and starts monitoring the second search space set. The WTRU receives a PDCCH in the second search space set. The WTRU monitors the first search space set after a configured time window (e.g., after the timer expiry and stops monitoring the second search space set).

In an example, the network may opportunistically use the SBFD symbols for downlink control signaling whenever the cross-link level interference is low. A fallback search space set, within non-SBFD symbols, may be used if the link quality is bad.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

Hereinafter, the term “subband” may be used to refer to a frequency-domain resource and may be characterized by at least one of the following: a set of resource blocks (RBs), a set of resource block sets (RB sets), (e.g. when a carrier has intra-cell guard bands, a set of interlaced resource blocks, a bandwidth part and/or portion thereof, and/or a carrier and/or a portion thereof etc.), for example. In an example, a subband may be characterized by a starting RB and number of RBs for a set of contiguous RBs within a bandwidth part. A subband may also be defined by a value of a frequency-domain resource allocation field and a bandwidth part index.

Hereinafter, the term “SBFD” may be used to refer to a subband-wise duplex (e.g., either UL or DL being used per subband) and may be characterized by, in cross division duplex (e.g., XDD, subband-wise FDD within a TDD band), a subband-based full duplex (e.g., full duplex as both the UL and the DL may be used and/or mixed on a symbol and/or slot, but either the UL or the DL being used per subband on the symbol and/or slot).

The term SBFD may be characterized by a frequency-domain multiplexing (FDM) of the DL and/or the UL transmissions within a TDD spectrum. The term SBFD may be characterized by a subband non-overlapping full duplex (e.g., non-overlapped sub-band full-duplex). The term SBFD may be characterized by a full duplex other than a same-frequency (e.g., spectrum sharing, subband-wise-overlapped) full duplex. The term SBFD may be characterized by an advanced duplex method, (e.g., other than (pure) TDD or FDD), partial in-band full duplex, subband overlapping full duplex, in-band full duplex (IBFD).

In an example, a property of a grant or assignment may include, but is not limited to, at least one of the following: a frequency allocation; an aspect of time allocation, such as a duration; a priority; a modulation and coding scheme; a transport block size; a number of spatial layers; a number of transport blocks; a TCI state; CRI or SRI; a number of repetitions, whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); any parameter provided in a DCI, by the MAC and/or by the RRC for the scheduling the grant and/or assignment etc.

In an example, an indication by the DCI may include, but is not limited to, at least one of the following: an explicit indication by a DCI field and/or by a RNTI used to mask a CRC of the PDCCH, and/or an implicit indication by a property such as a DCI format, a DCI size, a CORESET or search space, an aggregation level, a first resource element of the received DCI (e.g., an index of a first control channel element), where the mapping between the property and the value may be signaled by the RRC and/or the MAC etc.

Hereafter, a signal may be interchangeably used with one or more of following: a sounding reference signal (SRS), a channel state information-reference signal (CSI-RS), a demodulation reference signal (DM-RS), a phase tracking reference signal (PT-RS), a synchronization signal block (SSB), consistent with the present disclosure.

Hereafter, a channel may be interchangeably used with one or more of following: a physical downlink control channel (PDCCH), a physical downlink shared channel (PDSCH), a physical uplink control channel (PUCCH), a physical uplink shared channel (PUSCH), and/or a physical random access channel (PRACH), consistent with the present disclosure.

Hereafter, a downlink (DL) reception may be used interchangeably with an Rx occasion, the PDCCH, the PDSCH, and/or the SSB reception, consistent with the present disclosure.

Hereafter, the uplink (UL) transmission may be used interchangeably with Tx occasion, the PUCCH, the PUSCH, the PRACH, and/or the SRS transmission, consistent with the present disclosure.

Hereafter, the RS may be interchangeably used with one or more of: one or more RS resources, an RS resource set, an RS port and/or an RS port group, consistent with the present disclosure.

Hereafter, the RS may be interchangeably used with one or more of: the SSB, the CSI-RS, the SRS and/or the DM-RS, consistent with the present disclosure.

Hereafter, the time instance may be interchangeably used with a slot, a symbol, a subframe, consistent with the present disclosure.

Hereafter, UL-only and DL-only Tx and/or Rx occasions may interchangeably be used with legacy TDD UL and/or legacy TDD DL, respectively, consistent with the present disclosure. In an example, the legacy TDD UL and/or DL Tx and/or Rx occasions may be the cases where the SBFD is not configured and/or where the SBFD is disabled.

Hereafter, a UL signal (e.g., at least one of the SRS, the DMRS, the PUSCH, the PUCCH, the PRACH, and/or the PTRS, etc.) may be used interchangeably with a UL signal and/or channel, and/or a UL channel and/or signal, consistent with the present disclosure.

Hereafter, a DL signal (e.g., at least one of the CSI-RS, the SSB, the PDSCH, the PDCCH, the PBCH, and/or the PTRS, etc.) may be used interchangeably with a DL signal and/or channel, and/or a DL channel or signal, consistent with the present disclosure.

The WTRU may be configured with the SBFD in the frequency domain configuration. The SBFD frequency domain configuration may be associated with a carrier frequency and/or associated with a bandwidth part (BWP) of a carrier frequency. The SBFD frequency domain configuration may allocate some RBs of the BWP and/or the carrier for the UL and other RBs of the BWP and/or the carrier for the DL. The WTRU may be configured with the SBFD frequency domain configuration using a dedicated RRC signaling and/or a common broadcasted signaling (e.g., an SIB signaling). Hereafter, one or more resource blocks (RBs) and/or one or more resource elements (REs) may be interchangeably used with the REs, RBs, resource element groups (REGs), resource block groups (RBGs), frequency-units, subbands, bands, BWPs, component carriers, etc., consistent with the present disclosure. For example, any frequency-domain granularity as frequency-unit may be applicable in terms of whether full duplex (e.g., the SBFD) operation may be performed on one or more frequency-units.

The WTRU may be configured with a time domain configuration that indicates slots configuration for SBFD (i.e., a SBFD time domain configuration). For example, the WTRU may be configured with a first set of slots that may have only the SBFD symbols, a second set of slots that may have only the non-SBFD symbols (i.e., symbols where the entire BWP and/or the carrier is for configured for either UL or DL) and a third set of slots that may have both the SBFD and the non-SBFD symbols. The WTRU may be configured with the SBFD time domain configuration using a dedicated RRC signaling and/or common broadcasted signaling (e.g., an SIB signaling). Hereafter, the slots and/or symbols may be interchangeably used with the symbols, slots, sub-frames, frames, time-unit, etc., consistent with the present disclosure. For example, any time-domain granularity as time-unit may be applicable in terms of whether full duplex (e.g., the SBFD) operation may be performed on one or more time-units.

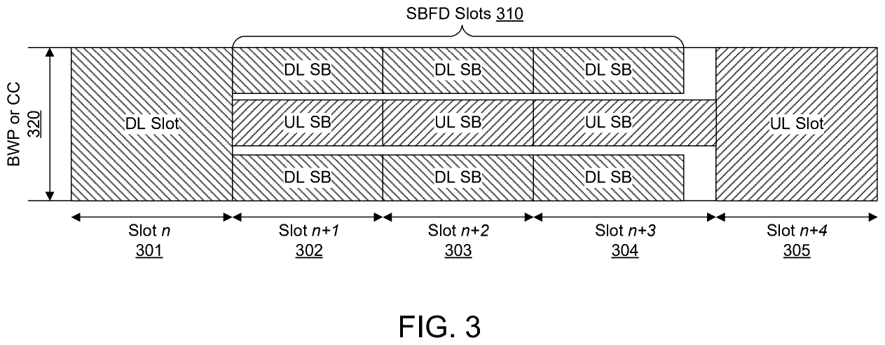

Referring now to FIG. 3, an example SBFD configuration is shown according to one or more embodiments. In an example, a WTRU may receive one or more configurations (e.g., configuration information) for an SBFD operation. The one or more configurations (e.g., the configuration information) may include the information on one or more time resources (e.g., the symbols and/or slots, etc.) where the SBFD (e.g., full duplex operation performed at the gNB) is applied. The configurations may include the information on one or more frequency resources in the configured SBFD time resources, for example for a first UL subband, a first DL subband, a first guard band, a first sidelink SB, a first flexible SB, and so forth. In an example, the WTRU may receive the one or more configurations via the DCI, the MAC-CE, the RRC, a system information block (SIB), a broadcast message, a multicast message toward a group of WTRUs, etc.

In an example, the WTRU may operate in half-duplex (HD) operation based on the one or more configurations, where the WTRU may either transmit the UL (or the sidelink) signal or receive a DL (or the sidelink) signal in a configured (or indicated) SBFD time instance. In another example (e.g., if configured by the gNB), the WTRU may operate in the FD operation (e.g., subband non-overlapping FD, subband partially and/or fully overlapping FD etc.) using a first set of SBFD configurations, where the WTRU may both transmit the UL (or the sidelink) signal and receive the DL (or the sidelink) signal in a configured (or indicated) SBFD time instance.

In an embodiment, the WTRU may receive the configuration information or the one or more configurations (e.g., from the gNB, the node, and/or the device) for a FD operation conducted by at least one device in a network. In an example, the FD operation may be conducted by the gNB (e.g., the BS, the node, the TRP, and/or the cell etc.). The WTRU may operate in a HD mode for communicating with the gNB, where the HD mode may imply at a given time the WTRU either performs the UL transmission or the DL reception (not both simultaneously at the given time). The WTRU may also operate in a FD mode for communicating with the gNB, for instance, if one or more corresponding WTRU capability signals are reported to the gNB and/or the WTRU receives a confirmation signal (e.g., enabling the FD and/or configuring the FD mode etc.) in response to transmitting the one or more WTRU capability signals.

The FD operation may imply at a given time a transmitter (e.g., the gNB and/or the WTRU) may simultaneously transmit a first signal and receive a second signal. The FD operation may include a subband overlapping FD (e.g., in-band FD (IBFD) etc.) operation where a first frequency-domain resource (e.g., the RBGs, the RBs, and/or the REs etc.) allocated for the first signal may have a full (or at least a partial) overlap with a second frequency-domain resource allocated for the second signal. The FD operation may comprise a subband non-overlapping FD (SBFD) operation where a first frequency-domain resource allocated for the first signal (e.g., assigned within the configured SBFD subband, e.g., a DL subband, one or more usable DL PRBs etc.) does not have an overlap with a second frequency-domain resource allocated for the second signal (e.g., assigned within a configured SBFD subband, e.g., a UL subband, one or more usable UL PRBs etc.).

In an implementation, the FD operation may comprise the SBFD operation, however the solutions, examples, embodiments, processes, and/or methods in the present disclosure may equally (or equivalently or extendedly, etc.) be employed (e.g., applicable) for cases with other FD operation types (e.g., the IBFD, etc.). The WTRU may receive the configuration and/or indication of multiple FD operation types (e.g., one or more multiple FD symbol types), where a first, a second, a third (or more) FD operation types (e.g., symbol types) may respectively indicate (e.g., correspond to) a non-SBFD operation (or symbol) type, an SBFD operation (or symbol) type, an IBFD operation (or symbol) type, and so forth, based on the configuration or indication (e.g., received from a BS, the gNB, cell, and/or the TRP, etc.).

The WTRU may receive one or more SBFD-related configurations, for example, for frequency-domain location information of one or more subbands (e.g., the DL subband, the UL subband, a flexible DL and/or UL subband, and/or a guardband etc.), and/or for time-domain location information of the one or more subbands. The time-domain location information may indicate first through fifth slots 301-305, including a set of SBFD slots 310, in a BWP 320. The BWP 320 includes a set of non-SBFD symbols and a set of SBFD symbols (e.g., as illustrated in FIG. 2). In an example, one or more symbols within the set of non-SBFD symbols may be a type of ‘DL symbol’, ‘UL symbol’ and/or ‘flexible symbol’. The WTRU may receive a DL signal on the one or more symbols based on a type of DL symbol in the set of non-SBFD symbols. The WTRU may transmit a UL signal on the one or more symbols based on a type of ‘UL symbol’ in the set of non-SBFD symbols. The WTRU may either receive a DL signal or transmit a UL signal on the one or more symbols) based on a type of ‘flexible symbol’ in the set of non-SBFD symbols (e.g., depending on one or more conditions with one or more other signals co-existing in the one or more symbols).

The WTRU may be configured, determined, and/or indicated to perform a measurement of cross-link interference (CLI) received signal strength indicator (RSSI) in a given time period, wherein the given time period may be the one or more slots, one or more OFDM symbols, one or more RBs, and/or one or more REs etc.). The CLI-RSSI which may be measured in a given time and/or frequency resource may be referred to as L1-CLI-RSSI, short-term CLI-RSSI, aperiodic CLI-RSSI, and so forth. Alternatively, the WTRU may be configured, determined, and/or indicated to perform a measurement of reference signal received power (RSRP) based on one or more reference signals (e.g., a SRS-RSRP) in a context of CLI measurement in a given time period, wherein the given time period may be the one or more slots, the one or more OFDM symbols, the one or more RBs, and/or the one or more REs etc. The SRS-RSRP which may be measured in the given time and frequency resource may be referred to as L1-SRS-RSRP, short-term SRS-RSRP, aperiodic SRS-RSRP, SRS-RSRP-CLI, and so forth.

Herein, the terms CLI-RSSI, L1-CLI-RSSI, and RSSI may be interchangeably used, consistent with the present disclosure. Herein, the terms SRS-RSRP, SRS-RSRP-CLI, L1-SRS-RSRP, and RSRP may be interchangeably used, consistent with the present disclosure.

For L1/L2 CLI measurement, one or more RSSI (or RSRP) types may be used and the WTRU may be configured to perform one or more RSSI (or RSRP) types, wherein a first RSSI (or RSRP) type may be based on a measurement over a long time period (e.g., more than one slot) (e.g., L3 measurements) and the measurement is reported via a higher layer signaling (e.g., the RRC and/or the MAC etc.); and a second RSSI (or RSRP) type may be based on a measurement over a short time period (e.g., L1 measurements) (e.g., one slot, within a slot, and/or the one or more OFDM symbols within a slot etc.) and the measurement is reported via a L1 signaling (e.g., the PUCCH, the PUSCH, the RACH, and/or the SRS etc.). The RSSI may be interchangeably used with the RSRP, the RSRQ, and/or the SINR. The CLI-RSSI may be interchangeably used with the SRS-RSRP and/or the SINR.

For the time and frequency resources, the WTRU may be configured with one or more sets of time and frequency resources for measuring the CLI (e.g., the SRS-RSRP) (e.g., a new IE SRS-RSRP-MeasurementResourceSet) including one or more sets of configuration information of one or more SRS-RSRP measurement resources (e.g., SRS-RSRP-MeasurementResource), for example for L1 SRS-RSRP measurement. The one or more SRS-RSRP measurement resource configurations may include a number of SRS ports, a transmission comb, a time resource mapping such as start position, a number of symbols, a repetition, the one or more frequency resources, a frequency hopping, a resource type such as periodic, aperiodic, semi-persistent, a sequence ID used for SRS, and so forth.

The WTRU may be configured with one or more sets of time and frequency resources for measuring the CLI (e.g., the CLI-RSSI) (e.g., a new IE CLI-RSSI-MeasurementResourceSet) including one or more sets of configuration information of the one or more CLI-RSSI measurement resources (e.g., CLI-RSSI-MeasurementResource), for example for L1 CLI-RSSI measurement. The one or more CLI-RSSI measurement resource configurations may include a CLI-RSSI measurement resource ID, starting PRB index, a number of PRBs, a starting symbol of the CLI-RSSI resource within a slot, a number of symbols of the CLI-RSSI resource within a slot, periodicity and/or a slot offset for the CLI-RSSI resource, and so forth.

In an implementation, the CLI measurement may include the CLI-RSSI measurement, however the solutions, methods, examples, systems, and/or processes in the disclosure may equally (or equivalently or extendedly, etc.) be employed (e.g., be applicable) for cases with other interference and/or the CLI measurements (e.g., the SRS-RSRP and/or the CLI-RSRP, etc.).

The WTRU may be configured with a set of time and frequency resources to measure L1-CLI-RSSI, wherein the time and frequency resources for the L1-CLI-RSSI measurement may be referred to as CLI-RSSI measurement resource (CRMR). The CRMR may be a resource configured, determined, and/or defined (e.g., via the RRC, the MAC-CE, and/or the DCI etc.) (e.g., via CLI-ResourceConfig, CLI-ResourceConfig-r-16, and so forth) with one or more of properties.

In an example, the one or more properties may include a set of muted REs in downlink resource (e.g., the PDSCH), wherein the set of muted REs may be rate-matched around or punctured for downlink reception and/or uplink transmission. In an example, the set of muted REs may have a same pattern (e.g., same time and frequency location) in each RB. In an example, the set of muted REs may have different patterns based on the RB location. For example, a first pattern may be used for the RBs located in an edge of the scheduled RBs and a second pattern may be used for the RBs located in a center of the scheduled RBs. The first pattern and the second pattern may have a different number of muted REs. The muted REs may be in a form of zero-power resources (e.g., CSI-RS and/or ZP-CSI-RS)

In an example, the one or more properties may include a set of REs not scheduled and/or used for the WTRU measuring CRMR.

In an example, the one or more of properties may include a set of REs may be located in an RB which may be configured or determined as guard band (or guard RB). A guard band (or guard RB) may be located in between uplink and downlink resources. The WTRU may skip receiving or transmitting a signal in guard band.

In an example, the one or more of properties may include one or more reference signals (e.g., the DMRS, the SRS, and/or the sidelink CSI-RS, etc.).

In an example, the one or more of properties may include a second set of DMRS REs within a second CDM group (e.g., within a scheduled downlink resource and/or RBs, e.g., of the PDSCH), where the WTRU may receive the DCI, scheduling the PDSCH, indicating the first set of DMRS REs corresponding to a first CDM group to be used for receiving the PDSCH. In an example, the WTRU may receive the DCI, scheduling the PDSCH, indicating a first set of DMRS REs corresponding to a first CDM group (based on an indicated ‘(DMRS) antenna port’ field of the DCI. In response to receiving the DCI, the WTRU may determine that a second set of DMRS Res within a second CDM group (other than the first CDM group) may be used as the CRMR (e.g., within the scheduled PDSCH).

In an example, the one or more of properties may be located within a scheduled resource (e.g., scheduled PDSCH RBs)

The CRMR may be configured commonly for a set of WTRUs (e.g., the WTRUs in proximity). For example, the gNB may configure the CRMR for a group of WTRUs, wherein the group of WTRUs may share one or more of following: a group-ID to receive a DCI (e.g., a group-RNTI), a zone-ID, wherein the zone-ID may be determined based on a geographical location of the WTRU (e.g., GNSS), the WTRUs paired for sidelink unicast (or groupcast) transmission.

The L1-CLI-RSSI measurement (including the CRMR resource) may be considered as a CSI reporting quantity and configured as a part of CSI reporting setting.

The CRMR may be configured in a first subband type (e.g., the DL subbands) to measure the (effect of) one or more reference signals received in a second subband type (e.g., UL subbands). As such, the reference signals may be received and measured in the resources that may be identified as zero-power and/or muted resources. The WTRU may be configured, determined, and/or indicated to measure the effect of reference signals being transmitted in other resources (e.g., a second type of resources, e.g., the UL subbands) in these resources (e.g., a first type of resources, e.g., the DL subbands). For example, a first WTRU may be configured to measure SRS-RSRP in the DL subbands on the SBFD configuration, where the SRS is transmitted by a second WTRU in the UL subbands. In an example, the first WTRU may measure the SRS-RSRP based on the configured SRS signaling in the DL subbands. In another example, the WTRU may measure the CLI-RSSI based on the configured SRS signaling in the UL subbands.

For a delta-CLI measurement, the WTRU may be configured, determined, and/or indicated to perform a delta CLI-RSSI, which may be based on a first CLI-RSSI measurement in a first time and/or frequency location and a second CLI-RSSI measurement in a second time and/or frequency location.

In an example, the delta CLI-RSSI (delta-CLI-RSSI) may be a difference between a first CLI-RSSI (e.g., CLI-RSSI₁) and a second CLI-RSSI (e.g., CLI-RSSI₂), e.g., delta-CLI-RSSI=CLI-RSSI₁-CL-RSSI₂ (or delta-CLI-RSSI=CLI-RSSI₂-CL-RSSI₁, etc.).

In an example, the first CLI-RSSI may be measured from the CRMR resources located in the edge of the scheduled RBs while the second CLI-RSSI may be measured from CRMR resources located in the middle of the scheduled RBs.

In an example, the WTRU may be configured with a first CRMR resource for the first CLI-RSSI measurement and a second CRMR resource for the second CLI-RSSI measurement.

In an example, the WTRU may determine to report the CLI measurement related information when a measured delta-CLI-RSSI is larger than a threshold. For example, the CLI reporting may be triggered based on delta-CLI-RSSI measurement is larger than a threshold, wherein the threshold may be predetermined or configured.

For bandwidth and/or subband configuration for the CLI measurement, the WTRU may be configured or determine to measure the CLI-RSSI per subband level. For example, the subband may be configured, and/or predetermined and the WTRU may perform the CLI-RSSI measurement in each subband.

In an example, the subband size may be determined based on the number of scheduled RBs (e.g., for the PDSCH).

In an example, the WTRU may report the CLI-RSSI measurement for all subbands.

In an example, the WTRU may report a subset of CLI-RSSI, wherein the subset may be determined based on one or more conditions (e.g., the CLI-RSSI value above threshold, subband location (e.g., edge of scheduled RBs), and/or subband index etc.).

In an example, the WTRU may determine a bandwidth of beam measurement and/or reporting (e.g., wideband or subband) based on one or more of following condition, for example, a time unit type (e.g., the SBFD and/or non-SBFD etc.). For example, the WTRU may report wideband CRI (e.g., wideband beam index) in the non-SBFD time units (e.g., a symbol, a slot, and so forth) and the WTRU may report subband CRI (e.g., a subband beam index) in the SBFD time units. An example of a condition includes a presence of the CLI-RSSI measurement. The bandwidth of beam measurement and/or reporting is determined based on whether the CLI-RSSI is measured in the same slot or not.

The WTRU may be indicated to perform the CLI-RSSI measurement in a specific frequency location within a scheduled RBs (and/or non-scheduled RBs), wherein the specific frequency location may be one or more of subbands, RBs, and/or REs etc.

In an example, the indication may be in the DCI which may trigger the CLI-RSSI measurement (e.g., aperiodic CLI-RSSI measurement).

In an example, the specific frequency location may be indicated based on the CRMR resource frequency location. For example, the one or more CRMR resources may be configured and each CRMR resource may be located in a specific frequency location based on configuration. The WTRU may be indicated to perform measurement on the CRMR resource indicated in the DCI.

In one or more examples, a carrier may refer to a frequency range and/or a part of the spectrum that may be used for transmission and/or reception by the WTRU and/or the gNB. The carrier may be characterized by one or more of the following, a frequency range, a set of frequency resources which may or may not be contiguous (e.g., a set of non-contiguous PRBs), a bandwidth (e.g., if the set of frequency resources of the carrier are contiguous), one or multiple BWPs, a carrier center, a sub-carrier spacing, a TRP, and/or a spectrum regulatory characteristics (e.g., an unlicensed spectrum etc.).

The carrier aggregation refers to multiple carriers configured for a WTRU, where data transmission and/or reception may occur in one or more aggregated carriers.

In an example, a carrier may refer to a secondary cell (SCell). An SBFD carrier refers to a carrier that is configured with SBFD configuration. A non-SBFD carrier refers to a carrier that is not configured with SBFD configuration.

In one or more embodiments, the WTRU may be configured with a first CORESET that may have frequency resources (e.g., the PRBs) in a downlink sub-band. The downlink sub-band may be collocated with an uplink sub-band and may experience the cross link interference from adjacent uplink transmissions. The WTRU may be configured with a second CORESET that may have frequency resources (e.g., PRBs) in the carriers that are not shared between downlink and uplink sub-band. In such case, the second CORESET may not suffer from cross link interference from the adjacent uplink transmissions.

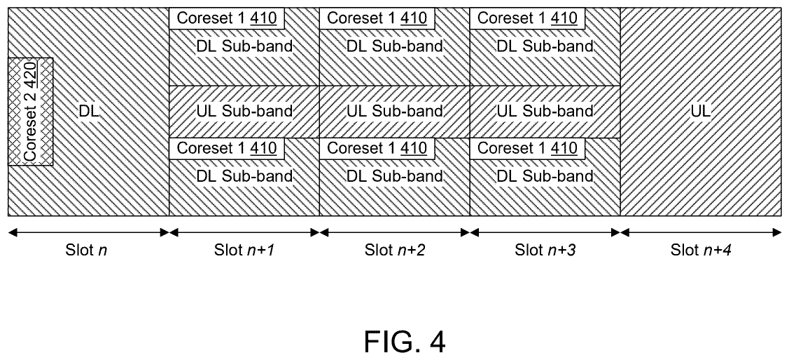

Referring now to FIG. 4, an example configuration of two CORESETs is shown according to one or more embodiments. The WTRU is configured with a first CORESET 410 (CORESET 1) that has frequency resources in a downlink sub-band and configured with a second CORESET 420 (CORESET 2) that has frequency resources in the carrier where the carrier is not shared with the uplink transmission.

In an example, the WTRU may be configured with a first search space set associated with the first CORESET 410 that consists of or includes FD (e.g., the SBFD) symbols. A search space set that includes the SBFD symbols may refer to a search space set that is configured with a PDCCH monitoring periodicity, a PDCCH monitoring offset and/or a PDCCH monitoring pattern within a slot that may result on the WTRU monitoring the PDCCH of the search space set only on the SBFD symbols. A search space set that includes the SBFD symbols may refer to a search space set that is configured with a PDCCH monitoring periodicity, PDCCH monitoring offset and PDCCH monitoring pattern within a slot that will result on the WTRU monitoring PDCCH of the search space set on the SBFD symbols in some monitoring occasions, and the WTRU monitoring the PDCCH of the search space set on non-FD (e.g., non-SBFD) symbols in other monitoring occasions.

The WTRU may be configured with a second search space set associated with the second CORESET 420 that includes the non-SBFD symbols. A search space set that includes the non-SBFD symbols may refer to a search space set that is configured with the PDCCH monitoring periodicity, the PDCCH monitoring offset and the PDCCH monitoring pattern within a slot that may result in the WTRU monitoring the PDCCH of the search space set only on the non-SBFD symbols.

In an example, the WTRU may be configured with the second search space set associated with a second CORESET that includes the non-SBFD symbols. The search space set that includes the non-SBFD symbols may refer to a search space set that is configured with the PDCCH monitoring periodicity, the PDCCH monitoring offset and the PDCCH monitoring pattern within a slot that will result in the WTRU monitoring the PDCCH of the search space set on the SBFD symbols in some monitoring occasions, and the WTRU monitoring the PDCCH of the search space set on the non-SBFD symbols in other monitoring occasions.

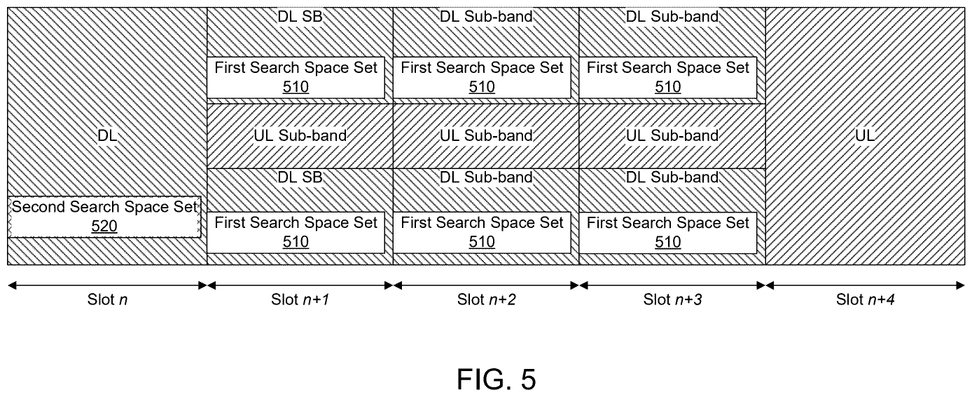

Referring now to FIG. 5, an example configuration of a first search space set 510 and a second search space set 520 is shown according to one or more embodiments.

One or multiple carriers may be configured for the WTRU to increase the data throughput. The configured carriers may be used for data transmission and/or reception. The WTRU may be configured with the SBFD time and frequency configurations in one or multiple carriers. The WTRU may receive an RRC configuration that indicates the SBFD time and/or frequency configurations for each of the carriers (separately, independently) and the applicable slots and/or symbols for the SBFD configuration. In one solution, the WTRU may receive a common SBFD configuration for multiple carriers (commonly, e.g., based on corresponding configuration by the network and/or based on a rule being pre-defined or pre-determined). For example, the SBFD configuration is common if the multiple carriers (e.g., for a group of carriers, for a subset of all configured carriers) are in the same band (e.g., intra-band carrier aggregation). In an example, the WTRU may receive a different SBFD configuration for each carrier. The SBFD configuration per carrier may have different link direction and/or different UL and/or DL subband size. In an example, the SBFD configuration is different if the multiple carriers are in different bands (e.g., inter-band carrier aggregation). The SBFD configuration for each carrier may include different frequency gap between the UL sub-band and the DL sub-band. The frequency gap between the UL and the DL sub-band may depend on the WTRU capability and may be different for each WTRU.

In an example, all the aggregated carriers for the WTRU may be configured with the SBFD configuration. In another example, some of the aggregated carriers for the WTRU may be configured with the SBFD configuration while other carriers are not configured with SBFD.

When the WTRU is configured with the carrier that is aggregated with the other SBFD carriers (regardless of whether this carrier has the SBFD configuration or not), the WTRU may be configured with multiple CORESETs for scheduling the transmission and/or reception in the carrier. The WTRU may be configured with multiple CORESETs for scheduling in the carrier, where some of the configured CORESETs may be within the carrier itself, and the other configured CORESETs may be within other carriers.

The WTRU may be configured with the first CORESET associated with the first search space set 510 that may have the frequency resources (e.g., the PRBs) in a downlink sub-band. For example, the WTRU is configured with an FD (e.g., the SBFD) carrier aggregated with a non-FD (e.g., the non-SBFD) carrier. The WTRU is configured the first CORESET in the SBFD carrier to schedule transmission and/or reception in that SBFD carrier. The WTRU may receive such configuration using the RRC signaling and/or other high layer signaling.

The WTRU may be configured with the second CORESET associated with the second search space set 520 that may have the frequency resources (e.g., the PRBs) in the carrier that are not shared between downlink and uplink sub-bands. For example, the WTRU is configured with an SBFD carrier aggregated with a non-SBFD carrier. The WTRU is configured with the second CORESET in the non-SBFD carrier to schedule transmission and/or reception in the SBFD carrier. The WTRU may receive such configuration using the RRC signaling and/or other high layer signaling.

In an example, a CORESET may belong to multiple carriers. For example, a CORESET may have some set of PRBs within a first carrier (e.g., the SBFD carrier) and another set of PRBs within a second carrier (e.g., the non-SBFD carrier). A search space set associated with such CORESET will have one or more PDCCH candidates spanning across multiple carriers. For example, a PDCCH candidate may have two CCEs in the first carrier and another CCE in the second carrier.

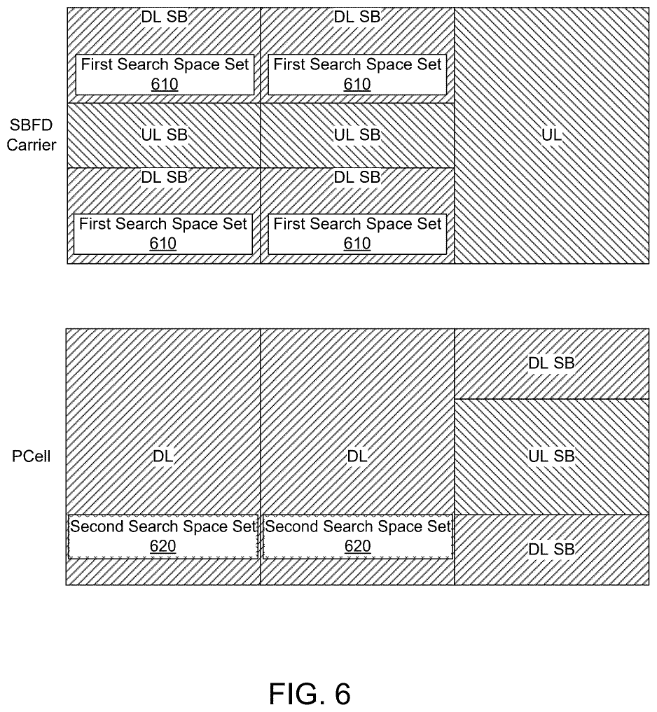

Referring now to FIG. 6, an example configuration of a first search space set 610 and a second search space set 620 with carrier aggregation is shown according to one or more embodiments. When the WTRU is configured with the carrier that is aggregated with other SBFD carriers (regardless of whether this carrier have the SBFD configuration or not), the WTRU may be configured with multiple search space sets (such as the first search space set 610 and the second search space set 620) for scheduling a transmission and/or a reception in the carrier. Some of the configured search space sets may be associated with the one or more CORESETs within the carrier itself, and the other search space sets may be associated with one or more CORESETs within the other carriers.

The WTRU may be configured with a first search space set associated with a first CORESET that includes one or more SBFD symbols. The WTRU may also be configured with a second search space set associated with a second CORESET that includes one or more non-SBFD symbols. In one example solution, the WTRU may be configured with a first search space set and a second search space set to schedule transmission and/or reception in the SBFD carrier. The first search space set may be configured in the SBFD carrier itself, and the second search space set may be configured in a non-SBFD carrier.

In an example, the second search space set may include the SBFD symbols i.e., the PDCCH monitoring occasion for the second search space set may occur in the SBFD symbols as well as in the non-SBFD symbols.

In an example, a search space set may be associated with multiple CORESETs that are within a different carrier. In such case, the PDCCH candidates of the search space set may include one or more CCEs in a first carrier and other CCEs in a second carrier. For example, a search space set may be associated with a first CORESET within a first carrier (e.g., the SBFD carrier) and a second CORESET within a second carrier (e.g., the non-SBFD carrier). The PDCCH candidate may have two CCEs in the first carrier and another CCE in the second carrier.

In an example, the WTRU may be configured to determine the search space sets to monitor based on the cross-link interference measured in the SBFD carrier. The WTRU may be configured to monitor all the configured search space sets for scheduling transmissions and/or receptions in the SBFD carrier and to stop monitoring one or more configured search space sets if the WTRU detects high CLI, (e.g., higher measured CLI than a threshold (being pre-determined or pre-configured)). The WTRU may determine a high level of cross link interference based on measuring a configured (and/or indicated) SRS and/or CLI-measurement resource (e.g., CLI-RSSI resource, L1-CLI-RSSI resource, or which may be a type of CSI resource and/or be shared with a CSI resource such as a ZP CSI-RS resource, etc.). For example, if the RSRP and/or RSSI measurement results are above a configured threshold, the WTRU may determine that there is a high level of cross link interference. In an example, the WTRU may be configured to monitor the first search space set that includes the SBFD symbols, and the second search space set that includes the non-SBFD symbols. The WTRU starts by monitoring both the first and second search space sets and if the WTRU detects high cross link interference, the WTRU stops monitoring the first search space set and only monitors the second search space set.

In another example solution, the WTRU may be configured to monitor the first search space set that includes the SBFD symbols, and to not monitor the second search space set that includes the non-SBFD symbols if the cross-link interference is not high i.e., the measurement results on the SRS, the CLI, and/or the CSI resources is below a configured threshold. If the WTRU detects high cross link interference, the WTRU stops monitoring the first search space set and starts monitoring the second search space set.

In some solutions, the WTRU may be configured to stop monitoring the first search space set and start monitoring the second search space set during a configured time window after detecting high level of CLI. The WTRU may be configured to start a timer when the WTRU stops monitoring the first search space set and starts monitoring the second search space set. For example, when the WTRU determines that the CLI is above the configured threshold, the WTRU starts a timer and stops monitoring the first search space set.

In an example, the WTRU may be configured to determine the search space sets to monitor based on the scheduling activity on the SBFD carrier. The WTRU may be configured to monitor all the configured search space sets for scheduling the transmissions and/or receptions in the SBFD carrier. The WTRU may stop monitoring the search space set associated with CORESET within the SBFD carrier itself if the WTRU is scheduled with a transmission in that carrier. For example, for scheduling in the SBFD carrier, the WTRU may be configured to monitor the first search space set that includes the SBFD symbols in the SBFD carrier, and the second search space set that includes the non-SBFD symbols in another carrier. When the WTRU receives a grant to transmit an uplink transmission in the SBFD carrier at slot n, the WTRU then stops monitoring the first search space set in slot n (or in slot n+k, where a value of offset parameter k may be pre-configured, or indicated or determined) and monitors only the second search space set. In another solution, the WTRU may be configured to monitor the first search space set that includes the SBFD symbols in the SBFD carrier, and to not monitor the second search space set until the WTRU receives a grant for uplink transmission in the SBFD carrier. When the WTRU receives a grant to transmit an uplink transmission in the SBFD carrier at slot n, the WTRU then stops monitoring the first search space set in slot n (or in slot n+k, where a value of offset parameter k may be pre-configured, or indicated or determined) and starts monitoring the second search space set.

In an example, the WTRU may be configured to monitor all the configured search space sets for scheduling transmissions and/or receptions in the SBFD carrier. The WTRU may prioritize monitoring one or more search space set based on its blind decoding capability. The WTRU may be configured to determine the one or more search space sets to monitor based on the blind decoding capability. The WTRU may be configured to monitor all the configured search space sets for scheduling transmissions and/or receptions in the SBFD carrier. The WTRU may stop monitoring the search space set associated with the CORESET within the SBFD carrier and/or within the SBFD symbols if the WTRU is configured, within a slot, with a number of PDCCH for blind decoding and/or number non-overlapping of the CCE for blind decoding above its capability (e.g., the WTRU supports a maximum number of PDCCH for blind decoding and/or number of non-overlapping CCE for blind decoding and the configured number of PDCCH and/or CCEs is above that maximum). For example, for scheduling in the SBFD carrier, the WTRU may be configured to monitor the first search space set that includes the SBFD symbols in the SBFD carrier, and the second search space set that includes non-SBFD symbols in another carrier. The first search space set is configured with the first PDCCH monitoring periodicity, the first PDCCH monitoring offset and the first PDCCH monitoring pattern. The second search space set is configured with the second PDCCH monitoring periodicity, the second PDCCH monitoring offset and the second PDCCH monitoring pattern. Such configuration results on having the WTRU to monitor PDCCH within the first and the second search space at some slots and/or symbols. If the WTRU determines that the total number of PDCCH and/or non-overlapping CCEs is above the WTRU capability, the WTRU stops monitoring the first search space and only monitors the second search space set during the slots and/or symbols where the WTRU is configured to monitor a larger number of PDCCH candidates and/or non-overlapping CCEs than its capability.

In an example, the WTRU may be configured to prioritize monitoring a sub-set of DCI formats when its blind decoding capability is exceeded (i.e., when the WTRU is configured with a number of the PDCCH candidates for blind decoding and/or number of the non-overlapping CCE above the capability of the WTRU). For example, the WTRU may be configured to prioritize monitoring a group common DCI (i.e., a DCI transmitted for a group of WTRUs) over a WTRU specific DCI. In another example, the WTRU may be configured to prioritize a fallback DCI over non-fallback DCI (i.e., a DCI format with minimum functionalities and does not require RRC configuration of some bitfield).

In an example, the WTRU may be configured to apply different search space set parameters for scheduling on the SBFD carrier when one or more of the following occurs, for example, the WTRU detects high level of CLI. For example, upon detecting high level of CLI, the WTRU applies different PDCCH monitoring periodicity to the search space set.

In an example, the WTRU reaches its blind decoding capability. For example, upon reaching its maximum blind decoding effort, the WTRU applies different PDCCH monitoring patterns within a slot to the search space set. In another example, the WTRU may monitor less DCI formats when the WTRU reaches its maximum blind decoding capability.

In an example, the WTRU is scheduled to transmit on the SBFD carrier. For example, when the WTRU is scheduled to transmit on the SBFD carrier, the WTRU applies different PDCCH monitoring offsets to the search space set.

In an example, the WTRU determines that quality metric associated with the signal strength based on the PDCCH (e.g. the PDCCH within the search space set) measurement is below a configured threshold. For example, the WTRU may use the RSSI, the SINR, and/or the RSRQ to determine the quality metric. The WTRU may determine the signal strength of the PDCCH using one or more of the following: a measurement of CSI-RS QCL:ed with PDCCH and/or measurement of PDCCH DMRS

The different search space set parameters may include one or more of the following: PDCCH monitoring periodicity, PDCCH monitoring offset, PDCCH monitoring pattern within a slot, and/or DCI formats to monitor within the search space set etc.

For example, the WTRU may be configured with the search space that may have the first PDCCH monitoring periodicity and the second PDCCH monitoring periodicity. The WTRU is configured to use the first PDCCH monitoring periodicity if the cross-link interference is below a configured threshold. The WTRU is configured to use the second PDCCH monitoring periodicity if the cross-link interference is above a configured threshold. The WTRU periodically measures the CLI on an SRS resource (e.g., layer1 (L1)-SRS-RSRP resource) and/or CLI-measurement resource (e.g., CLI-RSSI resource, L1-CLI-RSSI resource, a type of CSI resource, shared with a CSI resource such as a ZP-CSI-RS resource). When the WTRU determines that the CLI is above the threshold, the WTRU monitors the search space set using the second PDCCH monitoring periodicity.

In an example, the WTRU may be configured to indicate to the gNB that the WTRU stopped monitoring the configured search space set for scheduling in the SBFD carrier. The WTRU may be configured to indicate to the gNB that the WTRU stopped monitoring the configured search space set when one or more of the following occurs: cross link level in the carrier is above a threshold, failure to receive a downlink control information on the search space set for a configured time period, failure to receive a scheduling for a retransmission after reporting NACK for a HARQ process, receiving an uplink grant to transmit in the SBFD carrier, the WTRU's indication may be used as acknowledgement of receiving the grant, and/or the WTRU's blind decoding capability is exceeded etc.

In an example, the WTRU may be configured with the first search space set associated with the first CORESET that includes (or consist of) the SBFD symbols. The WTRU may be configured with the second search space set associated with the second CORESET that includes (or consists of) the non-SBFD symbols. Initially, the WTRU monitors the first search space set and does not monitor the second search space set. When the WTRU determines that the cross-link interference is high (e.g., the measured SRS RSRP (and/or the CLI-RSSI) is above the configured threshold), the WTRU stops monitoring the first search space and starts monitoring the second search space set during the configured window. For example, the WTRU starts a timer when the CLI is above a configured threshold and stops monitoring the second search space set. The WTRU may indicate to the gNB that it stopped monitoring the first search space set. The WTRU may transmit an uplink control information UCI in a PUCCH resource and/or PUSCH resource to indicate that the WTRU stopped monitoring the first search space. The WTRU may transmit a PUCCH resource (without UCI) when the WTRU stopped monitoring the first search space set. The WTRU may transmit a PRACH resource when the WTRU stopped monitoring the first search space set.

In an example, the WTRU may be configured to indicate to the gNB a high cross-link interference and wait for confirmation to stop monitoring the first search space set. For example, the WTRU may be configured to periodically measure the CLI on the configured SRS and/or the CLI resource and upon determining that the RSRP of the measured CLI and/or SRS resource, the WTRU transmits the PUCCH and/or the PUSCH to indicate to the gNB that the CLI is high. The WTRU keeps monitoring the first search space set after sending the PUCCH and/or PUSCH. The WTRU monitors the gNB confirmation to stop monitoring the first search space set for the configured time period (e.g., N slots after transmitting the PUCCH and/or PUSCH etc.).

In an example, the WTRU may receive the confirmation and/or indication to stop monitoring the first search space set. The WTRU may receive one or more of the following in the confirmation and/or indication message: a confirmation to stop monitoring first search space, an indication to keep monitoring the first search space set (the gNB requests the WTRU to keep monitoring the first search space even if e.g., there is high CLI), an indication on when to resume monitoring the first search space set (e.g., a number of slots after receiving the confirmation message), an indication of additional search space set to monitor while the first search space set is not monitored etc.

In an example, the WTRU may be configured to receive the confirmation and/or the indication to stop monitoring the first search space set in the second search space set. The WTRU starts monitoring the confirmation and/or the indication in the second search space after reporting high cross-link interference.

After the timer expiry, the WTRU may be configured to resume monitoring the first search space set. In one solution, the WTRU may be configured to stop monitoring the second search space set after resuming monitoring the first search space set. In another solution, the WTRU may be configured to continue monitoring the second search space set after the resuming monitoring the first search space set.

In various embodiments of the present disclosure, the WTRU is configured with at least two search space sets to schedule transmissions in a carrier configured with the SBFD. The WTRU is configured with the first search space set associated with the first CORESET that includes (or consists of) the SBFD symbols The WTRU is configured with the second search space set associated with the second CORESET that includes (or consists of) the non-SBFD symbols.

The WTRU monitors the first search space set for possible scheduling in the carrier.

The WTRU determines a high level of cross link interference in the carrier where the first CORESET is configured (e.g., the WTRU determines a high level of cross link interference based on the measurements results of configured SRS and/or CSI resource is above the configured threshold).

The WTRU stops monitoring the first search space set and monitors the second search space set.

The WTRU indicates to the gNB that the WTRU stopped monitoring the first search space set and started monitoring the second search space set (e.g., the WTRU transmits the indication in a PUCCH resource).

The WTRU stops monitoring the first search space set and starts monitoring the second search space set during the configured time window (e.g., the WTRU starts the timer when the CLI is above the configured threshold).

In an example, the WTRU indicates the high CLI to the gNB and waits for a confirmation to stop monitoring the first search space and start monitoring the second search space. When the WTRU receives the confirmation, the WTRU stops monitoring the first search space and starts monitoring the second search space.

The WTRU receives the PDCCH in the second search space set.

The WTRU monitors the first search space set after the configured time window (e.g., after the timer expiry and stops monitoring the second search space set).

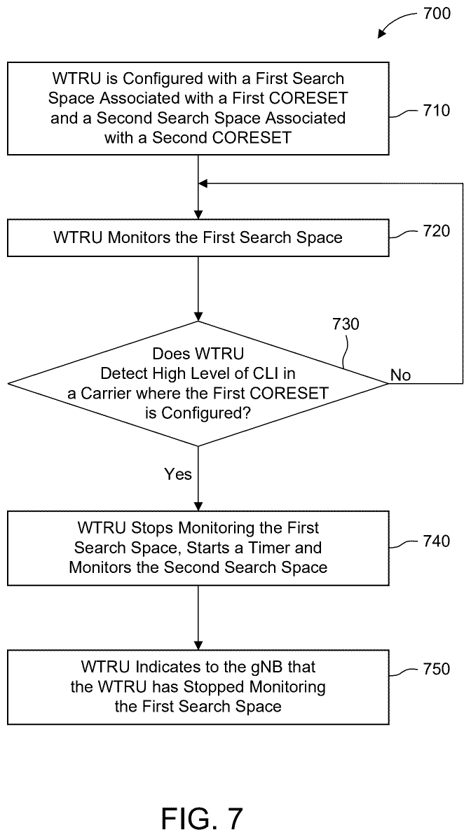

Referring now to FIG. 7, a flowchart illustrating an example process 700 of downlink control signaling for SBFD systems is shown according to one or more embodiments. The process is used by a WTRU.

At 710, the WTRU may be configured with one or more search spaces. The one or more search spaces may be associated with one or more CORESETS. For example, the WTRU may be configured with a first search space associated with a first CORESET and a second search space associated with a second CORESET. Alternatively or additionally, the WTRU may receive configuration information indicative of one or more search spaces associated with one or more CORESETS. For example, the WTRU may receive configuration information indicative of a first search space and a second search space. The first search space may be associated with the first CORESET comprising one or more SBFD symbols. The second search space may be associated with the second CORESET comprising one or more non-SBFD symbols.

At 720, the WTRU may monitor the first search space. For example, the WTRU may monitor the first search space for one or more channels. For example, the WTRU may monitor the first search space for a PDCCH. Alternatively or additionally, the WTRU may monitor the first search space and the second search space for the PDCCH.

At 730, the WTRU may measure a CLI in a carrier associated with the first search space. For example, the WTRU may measure one or more reference signal resources to determine the CLI. The WTRU may detect high level of CLI. For example, the WTRU may check if high level of CLI is detected in the carrier where the first CORESET is configured. In that, the WTRU may measure one or more reference signal resources and compare the one or more measurements with one or more configured threshold values (e.g., a threshold CLI). In one example, the WTRU may detect high CLI if the one or more measurements exceed the one or more configured threshold values. In another example, the WTRU may detect high CLI if the one or more measurements are less than the one or more configured threshold values.

If, at 730, the WTRU determines that high level of CLI is not detected in the carrier where the first CORESET is configured, then the WTRU may continue monitoring the first search space.

If, at 730, the WTRU determines that high level of CLI is detected in the carrier where the first CORESET is configured, then at 740, the WTRU may stop monitoring the first search space. The WTRU may initialize a timer for a configured time window. In an example, the WTRU may resume monitoring the first search space upon expiry of the timer. In an example, the WTRU may stop monitoring the second search space upon expiry of the timer. In an example, the WTRU may receive the PDCCH in the second search space within the configured time window. Alternatively or additionally, the WTRU may receive, from the base station, a confirmation indication in response to transmitting the indication of high CLI. In an example, the WTRU may stop monitoring the first search space based on the confirmation indication. In an example, the WTRU may monitor the second search space based on the confirmation indication.

At 750, the WTRU may indicate to a base station (e.g., gNB) that the WTRU has stopped monitoring the first search space. For example, the indication of high CLI may be transmitted using at least one of: PUCCH or PUSCH.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU), comprising:
a transceiver; and
a processor, wherein the transceiver and the processor are configured to:
receive configuration information indicative of a first search space and a second search space, wherein the first search space is associated with a first control resource set (CORESET) comprising one or more subband full-duplex (SBFD) symbols and the second search space is associated with a second CORESET comprising one or more non-SBFD symbols;
monitor the first search space for a physical downlink control channel (PDCCH);
measure a cross link interference (CLI) in a carrier associated with the first search space;
determine that the measured CLI is greater than a threshold CLI;
stop monitoring the first search space;
monitor the second search space; and
transmit, to a base station, an indication of high CLI.

2. The WTRU of claim 1, wherein the transceiver and the processor are further configured to:
determine that the measured CLI is not greater than the threshold CLI; and
continue monitoring the first search space.

3. The WTRU of claim 1, wherein the transceiver and the processor are further configured to:
based on the determination that the measured CLI is greater than the threshold CLI, initialize a timer for a configured time window;
resume monitoring the first search space upon expiry of the timer; and
stop monitoring the second search space upon expiry of the timer.

4. The WTRU of claim 3, wherein the transceiver and the processor are further configured to:
based on the determination that the measured CLI is greater than the threshold CLI, receive the PDCCH in the second search space within the configured time window.

5. The WTRU of claim 1, wherein the transceiver and the processor are further configured to:
based on the determination that the measured CLI is greater than the threshold CLI, receive, from the base station, a confirmation indication in response to transmitting the indication of high CLI;
stop monitoring the first search space based on the confirmation indication; and
monitor the second search space based on the confirmation indication.

6. The WTRU of claim 1, wherein the indication of high CLI is transmitted using at least one of: physical uplink control channel (PUCCH) or physical uplink shared channel (PUSCH).

7. The WTRU of claim 1, wherein measuring the CLI comprises measuring one or more reference signal resources.

8. A method for use in a wireless transmit/receive unit (WTRU), the method comprising:
receiving configuration information indicative of a first search space and a second search space, wherein the first search space is associated with a first control resource set (CORESET) comprising one or more subband full-duplex (SBFD) symbols and the second search space is associated with a second CORESET comprising one or more non-SBFD symbols;
monitoring the first search space for physical downlink control channel (PDCCH);
measuring a cross link interference (CLI) in a carrier associated with the first search space;
determining that the measured CLI is greater than a threshold CLI;
stopping monitoring the first search space;
monitoring the second search space; and
transmitting, to a base station, an indication of high CLI.

9. The method of claim 8, the method further comprising:
determining that the measured CLI is not greater than the threshold CLI; and
continuing monitoring the first search space.

10. The method of claim 9, the method further comprising:
based on the determination that the measured CLI is greater than the threshold CLI, initializing a timer for a configured time window;
resuming monitoring the first search space upon expiry of the timer; and
stopping monitoring the second search space upon expiry of the timer.

11. The method of claim 10, the method further comprising:
based on the determination that the measured CLI is greater than the threshold CLI, receiving the PDCCH in the second search space within the configured time window.

12. The method of claim 9, the method further comprising:
based on the determination that the measured CLI is greater than the threshold CLI, receiving, from the base station, a confirmation indication in response to transmitting the indication of high CLI;
stopping monitoring the first search space based on the confirmation indication; and
monitoring the second search space based on the confirmation indication.

13. The method of claim 8, wherein the indication of high CLI is transmitted using at least one of: physical uplink control channel (PUCCH) or physical uplink shared channel (PUSCH).

14. The method of claim 8, wherein measuring the CLI comprises measuring one or more reference signal resources.

15. A wireless transmit/receive unit (WTRU), comprising:
a transceiver; and
a processor, wherein the transceiver and the processor are configured to:
receive configuration information indicative of a first search space and a second search space, wherein the first search space is associated with a first control resource set (CORESET) comprising one or more subband full-duplex (SBFD) symbols and the second search space is associated with a second CORESET comprising one or more non-SBFD symbols;
monitor the first search space and the second search space for physical downlink control channel (PDCCH);
measure a cross link interference (CLI) in a carrier associated with the first search space;
determine that the measured CLI is greater than a threshold CLI;
stop monitoring the first search space; and
transmit, to a base station, an indication of high CLI.

16. The WTRU of claim 15, wherein the transceiver and the processor are further configured to:
determine that the measured CLI is not greater than the threshold CLI; and
continue monitoring the first search space.

17. The WTRU of claim 15, wherein the transceiver and the processor are further configured to:
based on the determination that the measured CLI is greater than the threshold CLI, initialize a timer for a configured time window; and
resume monitoring the first search space upon expiry of the timer.

18. The WTRU of claim 17, wherein the transceiver and the processor are further configured to:
based on the determination that the measured CLI is greater than the threshold CLI, receive the PDCCH in the second search space within the configured time window.

19. The WTRU of claim 15, wherein the transceiver and the processor are further configured to:
based on the determination that the measured CLI is greater than the threshold CLI, receive, from the base station, a confirmation indication in response to transmitting the indication of high CLI; and
stop monitoring the first search space based on the confirmation indication.

20. The WTRU of claim 15, wherein the indication of high CLI is transmitted using at least one of: physical uplink control channel (PUCCH) or physical uplink shared channel (PUSCH).
